(19) United States
(12) Patent Application Publication
(10) Pub. No.: US 2018/0354603 A1
(43) Pub. Date: Dec. 13, 2018

(54) AIRCRAFT WING STRUCTURE

(71) Applicant: Andrew Charles Elson, Maesbury (GB)

(72) Inventor: Andrew Charles Elson, Maesbury (GB)

(21) Appl. No.: 15/761,722

(22) PCT Filed: Sep. 19, 2016
(86) PCT No.: PCT/GB2016/052916

§ 371 Date: Mar. 20, 2018

(30) Foreign Application Priority Data
Sep. 21, 2015 (GB) 1516713.3

(51) Int. Cl. B64C 3/22; B64C 39/02; B64C 3/26; B64C 3/18

(52) U.S. Cl. CPC B64C 3/22; B64C 39/024; B64C 3/26; B64C 3/185; B64C 3/187; B64C 2201/165; B64C 2201/042; B64C 2201/066; B64C 2201/082; B64C 2201/104; B64C 2201/021

(57) ABSTRACT

An aircraft has a wing providing the main lifting surface for the aircraft. The wing has a structure supporting an aero-dynamic surface, and the wing has a weight, the wing structure being unable to support its own weight when the aircraft is stationary and under a load of 1 g so as to cause structural failure of the wing.

### FIELD OF THE INVENTION

The present invention relates to an aircraft, to the wing of the aircraft and to a method of launching the aircraft.

### BACKGROUND OF THE INVENTION

An unmanned aerial vehicle (UAV) may be adapted for extreme duration flights in the stratosphere.

Flight at stratospheric altitudes has the advantage that the stratosphere exhibits very stable atmospheric conditions, with wind strengths and turbulence levels at a minimum between altitudes of approximately 18 to 30 kilometres. Stable environmental conditions are preferable for a variety of applications such as mapping and surveillance, and may be advantageous as they can minimise the external load bearing requirements of the aircraft structure in flight.

Weight is a key issue for any aircraft designer and particularly for a UAV optimised for extreme duration flight.

US 2006/0278757 describes a method of launching a UAV, where the UAV is carried to its operational altitude suspended on a tether from a helium balloon. The tether is attached at or towards a tip of the UAV's wing so that it is carried in effectively a 90° banked attitude. At the desired altitude the UAV's powerplant is started and it flies on its tether in an upwardly-spiralling path relative to the balloon until a level or near level attitude is attained, when the tether is released and the UAV is permitted to assume free flight.

### SUMMARY OF THE INVENTION

A first aspect of the invention provides an aircraft comprising a wing providing the main lifting surface for the aircraft, the wing having a structure supporting an aerodynamic surface, wherein the wing has a weight, the wing structure being unable to support its own weight when the aircraft is stationary and under a load of 1 g so as to cause structural failure of the wing.

A second aspect of the invention provides a method of launching an aircraft, the aircraft being in accordance with the first aspect, wherein the aircraft is lifted from a substantially ground level location to an elevated altitude by a lighter than air carrier.

Stationary means that the aircraft is not moving relative to the surrounding air, i.e. the aircraft is not in flight. ‘1 g’ is defined as the acceleration due to gravity at the Earth's surface. Structural failure is defined as the loss of load-carrying capacity of a component or member within the wing structure or of the wing itself. Such failure may take the form of a fracture or complete break in the wing structure, or may be excessive deformation such that the wing structure has plastically rather than elastically deformed.

Flying a UAV for long durations in the stratosphere requires an extremely lightweight aircraft—the lighter the aircraft, the less energy will be required to power the aircraft over the flight duration, thereby allowing the potential flight duration to be maximised. Similarly, a long wingspan maximises the lift generation capability of the aircraft in flight and again leads to a lower propulsion power requirement.

The aircraft structure should also be sufficiently robust, dimensioned and proportioned to carry payload (for example auxiliary batteries, cameras etc), as well as potentially supporting a number of additional load conditions. The design load conditions for a typical aircraft include the load the aircraft must support during launch, flight, landing and on the ground. The inventor has made the insight that it is not a requirement for an aircraft adapted for flight in the stratosphere to support its own weight on the ground. Removing design constraints on the strength and rigidity of the aircraft structure in this way enables the weight of the aircraft to be further optimised for flight and hence reduced, to the extent that the aircraft wing structure is unable to support its own weight on the ground.

Launching by lifting the aircraft to altitude attached to a carrier allows the aircraft to be carried upwards by the carrier through key risk areas of high wind loads at altitudes below the stratosphere. The aircraft is supported during the lift and is not required to fly.

Stable flight conditions at altitude also obviate the need for the aircraft structure to withstand significant external loading in flight. The aircraft begins flight and remains flying in the stratosphere until it is ordered to descend to ground level. Thus, the aircraft can be lighter and more fragile than would be possible for an aircraft adapted for ground level take off

The wing may be adapted to generate lift when the aircraft is moving relative to the surrounding air to achieve sustained flight, and the wing structure may be able to support its own weight under a load of 1 g during flight.

The wing structure may be unable to support its own weight when the aircraft is stationary and under a load of 0.5 g so as to cause structural failure of the wing.

The aircraft may be an unmanned vehicle. An unmanned aerial vehicle (UAV), also referred to as an unpiloted aerial vehicle or a remotely piloted aircraft (RPA) by the International Civil Aviation Organization (ICAO), is defined as an aircraft piloted by remote control or onboard computers, i.e. there is no human pilot aboard. A UAV used for military purposes is typically known as a drone. Model aeroplanes are largely flown within visual line of sight and in the presence of an operator who watches and maintains control of the airplane during flight. A UAV is not limited in this way, indeed the UAV of the present invention is designed to fly at an altitude far higher than the visual line of sight. Long or extreme endurance means that the aircraft is capable of independent flight for extended periods, such as days, weeks, months or possibly even years.

The structure of the wing may comprise at least one space frame and at least one cover supported by the space frame, wherein the space frame has one or more structural members, the structural members including a structural foam material. The cover may be pre-stressed and the pre-stressed cover has the aerodynamic surface of the wing. The space frame may comprise one or more chordwise ribs and one or more spanwise spars. The structural member(s) may consist of a structural foam material.

A space frame is defined as a three-dimensional structural framework which is designed to behave as an integral unit and to withstand loads applied at any point. The frame or framework is the rigid supporting structure of the aerofoil that assists in defining the shape of the aerofoil and, because it surrounds vacant space, is termed a space frame. The space frame may be constructed from interlocking struts or may have the frame structure hollowed out of a block of raw material or be formed via an additive layer manufacturing process, building the framework layer by layer. If manufactured as a single component, the structural members may therefore be integrally connected, or the framework may be considered to have a single structural member. Space frames can be used to span large areas with few interior supports, which thus makes the space frame an effective structure when designing for lightweight applications.

Structural foam material is foam that has been formed via a process of injecting an inert gas (e.g. nitrogen) through a melted polymer to form a foam, which is then moulded. The foam expands in the mould resulting in an outer skin which is denser than the core, and a final moulding that has a lower weight and increased stiffness relative to a standard injection moulded product. The polymer used may be any thermoplastic polymer, commonly used examples are polystyrene, polycarbonate, polyvinylchloride, polypropylene, acrylonitrile-butadiene-styrene (ABS) or a polymethacrylimide (PMI) such as that used in Rohacell™ structural foam. Rohacell™ 31 IG-F has been chosen as an example due to the key properties of the material: it is lightweight, dimensionally stable with temperature and exposure to ultraviolet light, and closed cell and therefore not hydroscopic. Other manufacturers of structural foam include Gurit and Polycel.

The aircraft carries a payload and the total weight of the aircraft is comprised of greater than 30% payload, preferably greater than 40% payload and more preferably greater than 50% payload. Payload relates to items carried by the vehicle which do not contribute directly to the flight of the vehicle, e.g. are not involved in providing lift, structure or propulsion. Payload therefore includes any solar collectors not provided for propulsion, auxiliary batteries and other functional equipment such as cameras, receivers, transmitters, geopositional systems, antennas etc carried by the vehicle.

The aircraft may have powered propulsion, comprising at least one propeller powered by a motor. The aircraft may be solar powered, comprising solar energy collectors and batteries for storing electrical energy.

The aircraft excluding any payload may have a mass of between 30 kg to 150 kg. The aircraft wing may have a span of from 20 to 60 metres.

The aircraft may have no landing gear. The landing gear refers to the assembly of wheels, floats, skids or similar, as well as shock absorbers, struts etc that supports a typical aircraft on the ground and enables the aircraft to take off and land. The aircraft of the invention may have no landing gear of any description and may also simply not be designed for a runway or strip landing.

The method of launching the aircraft may include the aircraft being attached to the lighter than air carrier via one or more tethers during ascent from the substantially ground level location to the elevated altitude, the tethers being severed at altitude to launch the aircraft. The elevated altitude may be from 18,000 to 30,000 metres.

### BRIEF DESCRIPTION OF THE DRAWINGS

Embodiments of the invention will now be described with reference to the accompanying drawings, in which:

FIG. 1 is a perspective view of an unmanned aerial vehicle in flight,

FIG. 2 is a perspective view of a stationary UAV on the ground, with unsupported wings, showing how one wing has failed,

FIG. 3a is a perspective partially exploded view of the wing structure of the UAV without the aerodynamic surface,

FIG. 3b is a perspective view of the wing structure of the UAV of FIG. 3a with the upper and lower covers and the aerodynamic surface assembled,

FIG. 4 is a perspective view of the UAV at altitude, having just been released from the lighter than air carrier, and

FIG. 5A-5G are perspective views of an exemplary launch and release method of a UAV.

### DETAILED DESCRIPTION OF EMBODIMENT(S)

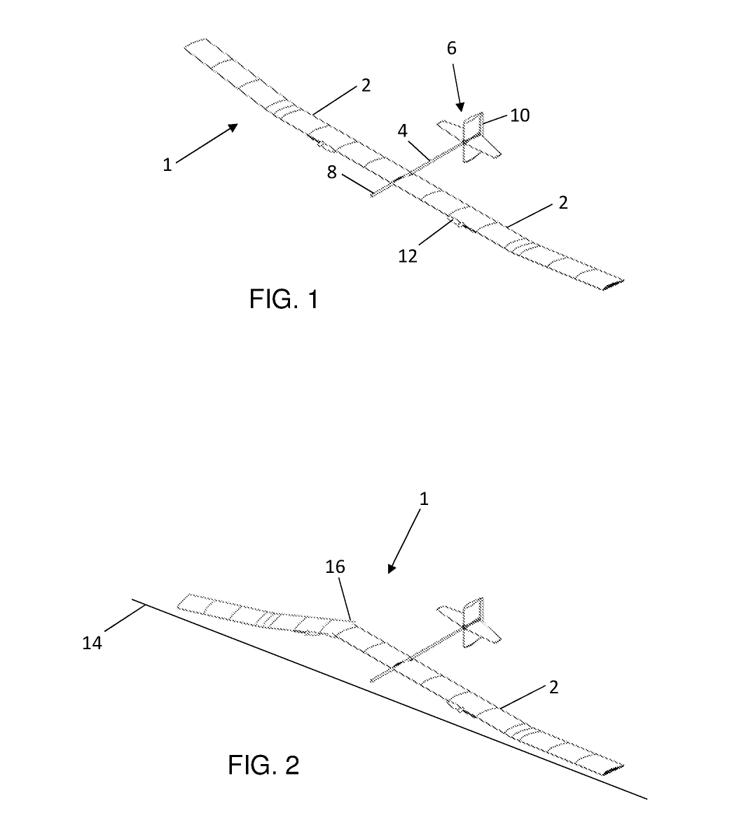

In an embodiment, the aircraft is a UAV 1 having two wings 2, a fuselage 4, and a tailplane 6, as shown in FIG. 1.

In this embodiment the fuselage 4 is a minimal structure, comprising simply a lightweight tube, with the wings 2 and tailplane 6 attached to the tube. The tube is of carbon fibre construction, having a diameter in the range of 60 to 120 mm and a wall section of 0.5 mm. In alternative embodiments, the fuselage may be constructed of any lightweight material, for example wood, plastic or fibre reinforced composite, and may be hollow or solid, and of any shape suitable for having wings and tailplane attached. The shape and dimensions of the fuselage may vary along the length of the fuselage, for example to provide weight balance, and may be elliptical or tapered. The nose 8 of the fuselage extends forwards of the wings and acts to counter balance the weight of the tailplane. The nose 8 also provides optional payload storage capacity.

The tailplane 6 has cruciform vertical and horizontal stabilising surfaces attached to the fuselage 4. The trailing portion of the stabiliser has an active movable rudder 10 located at the upper and lower portion of the vertical stabilising surface. An actuator controls the rudder 10, the actuator being located in the tailplane 6.

The wings 2 are elongate in a spanwise direction with a total wingspan of around 20 to 60 metres, extending either side of the fuselage 4. The wing may be straight or tapered in the outboard direction, and the wings may be horizontal or have a dihedral or an anhedral angle from the point the wing meets the fuselage, or from any point along the wing.

Each of the wings 2 carry a motor driven propeller 12 which may be powered by rechargeable batteries, or the batteries may be recharged during flight via solar energy collecting cells (not shown) located on the external surface of the aircraft. Each propeller is lightweight, in an embodiment the propellers each weigh less than one kilogram and are greater than 2 metres in length. FIG. 1 shows each wing carrying a single propeller, however in alternative embodiments multiple propellers may be provided on each wing. The propellers are shaped for high altitude, low speed flight. The payload of the vehicle is also carried mainly within the wing structure.

FIG. 1 shows the UAV 1 in sustained flight, with the wings 2 generating lift and the wing structure able to support its own weight. FIG. 2 shows the UAV 1 stationary and on the ground 14. In FIG. 2 the UAV 1 has not been supported on the ground and failure of the wings 2 has therefore occurred at least at point 16 along one of the wings 2. Failure may take the form of a fracture or complete break in the wing structure, as shown in FIG. 2, or may be excessive deformation such that the wing structure has plastically rather than elastically deformed and is therefore unable to support flight of the aircraft. Failure occurs as a result of the wing 2 being unable to support its own weight at the Earth's surface, i.e. under a loading of 1 g. In fact, the wings 2 are so fragile that each wing may be unable to support its own weight under a loading of less than 1 g, and will break when subjected to a load of, for example, 0.5 g.

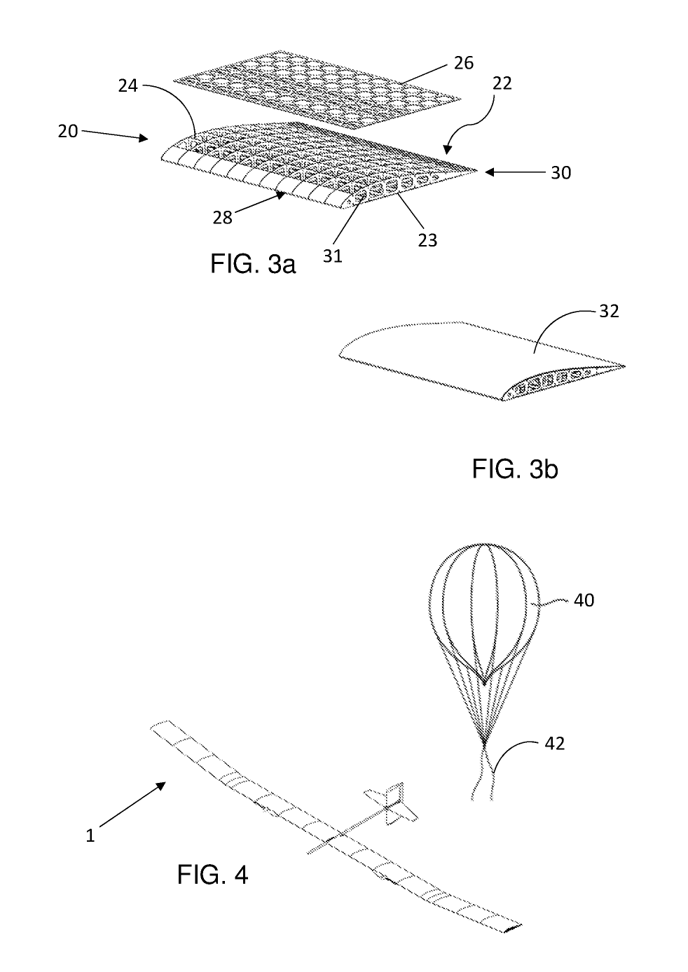

In an embodiment, each wing 2 comprises an aerofoil 20 as shown in the exploded perspective view of FIG. 3a. The aerofoil 20 comprises a space frame 22 having a plurality of ribs 23 and spars 24, a cover 10 including an upper cover (skin) 26, a lower cover (skin) not visible in FIG. 3a, a leading edge assembly 28, a trailing edge assembly 30, and also includes an aerodynamic surface membrane 32 (shown in FIG. 3b). The aerofoil 20 has a cambered, low speed profile with a sharp leading edge radius.

The ribs 23 extend chordwise across the aerofoil 20, and are spaced equidistantly apart in a spanwise direction. Each rib 23 is of similar overall shape and dimension. Each spar 24 extends spanwise along the length of the aerofoil 20 and comprises an upper spar section and a lower spar section. The profile of the upper and lower spar sections varies chordwise across the aerofoil 22 according to the shape of the aerofoil 22, the upper and lower spar sections having a larger vertical cross-section at the quarter chord position. The space frame 22 is assembled by inserting slots in each lower spar into slots along the lower edge of each rib 23, and then repeating the process for all subsequent ribs 23. Similarly, slots in each upper spar insert into slots along the upper edge of each rib 23.

The ribs 23 and upper and lower spar sections are formed by cutting the rib or spar profile from a sheet of structural foam. The material thickness is of the order of 4 mm, but may be thinner for example 2 mm or 3 mm, or could also be thicker than 4mm. In this embodiment, the ribs and spar sections are cut from structural foam material of the same thickness, alternative embodiments may have specific ribs and/or spars of a differing material thickness. The structural foam used is Rohacell™ 31 IG-F although there are a number of structural foam types suitable for use, as long as the key features of lightweight combined with rigidity are present. Rohacell™ 31 IG-F is the lightest grade of structural foam currently available, with the finest cell structure. Other products with an equivalent density have a coarser cell structure and surfaces are therefore not as suitable for bonding. Heavier grades of structural foam would provide an increased stiffness, but at an increased weight.

FIG. 3b shows the assembled aerofoil including the aerodynamic surface membrane 90. The membrane is pre-stressed and then stretched over the aerofoil and taped on to the aerofoil. This enables the aerofoil to behave as a monocoque structure, i.e. the membrane becomes a structural component also and increases the loads that can be supported by the aerofoil. The membrane may be of any lightweight material that is dimensionally stable both with temperature and under UV light conditions, whilst providing good tensile strength to weight ratio. In this embodiment, a polyimide film such as Kapton™ is used, with a thickness of 12.5 micron. Alternatives include Mylar film.

With the upper 28 and lower 26 covers assembled on to the space frame 22, the aerofoil structure comprises multiple hollow cells 31 formed by adjacent ribs, spars and upper 28 and lower 26 covers. The payload is carried inside these hollow sections 31, typically along successive hollow sections formed at the quarter chord position, where the hollow sections have the largest dimensions. Optional reinforcement the area of the aerofoil carrying the payload may be provided, for example one or more additional reinforcing spars can be located either side of the hollow cells 31 carrying the payload. Additionally, the lower face of the hollow cells 31 carrying payload can also be reinforced and shaped so as to facilitate location of items or cables within particular hollow cells 31.

Payload is distributed within the wing so as to balance the centre of mass of the wing and payload with the centre of lift of the wing within a predetermined range for the defined flying characteristics.

The UAV 1 is lifted to altitude by a balloon 40 in a wingtip up configuration and then reoriented at altitude in readiness for release. The UAV 1 is attached to the balloon during the lift phase by one or more tethers 42. FIG. 4 shows the UAV 1 having reached its launch altitude and the tethers 42 attaching the UAV 1 to the balloon 40 having been released. The UAV 1 is thereby released into its flight mode.

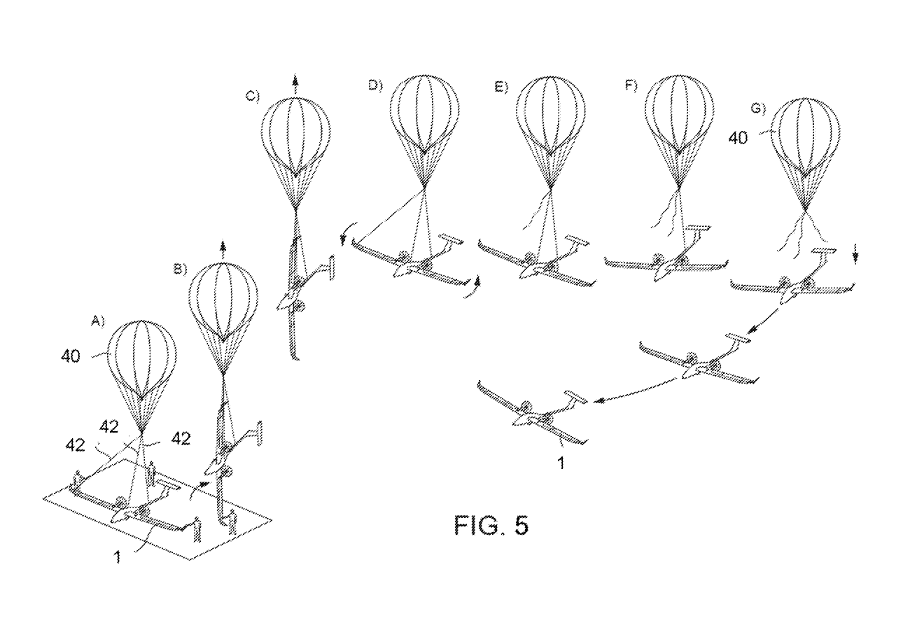

FIG. 5 shows the method of launching an aircraft of the invention. The design detail of the aircraft in FIG. 5 differs in a number of ways when compared to the UAV shown in FIGS. 1, 2 and 4. For example, the aircraft in FIG. 5 has a larger fuselage and a T-tail design of tailplane, with the horizontal stabiliser located at the end of the vertical stabiliser. The propeller design and location on the wing also differs. However, the method of launching is equally applicable to both aircraft designs, and is not intended to be limited to an aircraft of particular proportion or detail design.

FIG. 5 shows an unmanned aerial vehicle 1 attached to a lighter-than-air balloon 40 acting as the carrier at a ground level location at stage A. The UAV 1 is attached to the balloon by three tethers 42, one attached to a wing-tip and two attached to the fuselage. The method is similar to that described with reference to WO 2014/013268, the contents of which are incorporated herein by reference.

During launch, the balloon 40 lifts the UAV 1 which enters a wing-tip-up orientation, as shown in stage B, achieved by pulling on the tether attached to the wing-tip.

The balloon 40 then begins the ascent, carrying the UAV 1 suspended below in a wing-tip-up orientation, as shown in stage C.

Once at the launch altitude the UAV 1 is moved back into a horizontal attitude by letting out the tether 42 attached to the wing-tip, as shown in stage D.

The tether 42 attached to the wing-tip is then severed, together with one of the tethers attached to the fuselage, causing the UAV 1 to enter a nose-down configuration, as shown in stage E and F.

Finally the last tether 42 is severed, releasing the UAV to begin its descent, as shown in stage G. The motors are powered and the UAV increases flight velocity until the descent is controlled and the UAV 1 is capable of independent flight.

The UAV 1 may have a flight duration of days, weeks, months or possibly even years. At the end of the mission, the UAV 1 is required to land. Since the UAV 1 does not possess any landing gear structure, landing on a runway may not be possible. The UAV 1 may be designed to crash land, be caught in a net or land on a moving platform in the vicinity of the landing location for example.

Although the invention has been described above with reference to one or more preferred embodiments, it will be appreciated that various changes or modifications may be made without departing from the scope of the invention as defined in the appended claims.

What is claimed is:

1. An aircraft comprising a wing providing the main lifting surface for the aircraft, the wing having a structure supporting an aerodynamic surface, wherein the wing has a weight, the wing structure being unable to support its own weight when the aircraft is stationary and under a load of 1 g so as to cause structural failure of the wing.

2. An aircraft according to claim 1, wherein the wing is adapted to generate lift when the aircraft is moving relative to the surrounding air to achieve sustained flight, and the wing structure is able to support its own weight under a load of 1 g during flight.

3. An aircraft according to claim 1, wherein the wing structure is unable to support its own weight when the aircraft is stationary and under a load of 0.5 g so as to cause structural failure of the wing.

4. An aircraft according to claim 1, wherein the aircraft has powered propulsion.

5. An aircraft according to claim 4, wherein the aircraft comprises at least one propeller powered by a motor.

6. An aircraft according to claim 4, wherein the aircraft is solar powered, comprising solar energy collectors and batteries for storing electrical energy.

7. An aircraft according to claim 1, wherein the aircraft carries a payload and the total weight of the aircraft is comprised of greater than 30% payload, preferably greater than 40% payload and more preferably greater than 50% payload.

8. An aircraft according to claim 1, wherein the aircraft is an unmanned vehicle.

9. An aircraft according to claim 1, wherein the aircraft excluding any payload has a mass of between 30 kg to 150 kg.

10. An aircraft according to claim 1, wherein the aircraft wing has a span of from 20 to 60 metres.

11. An aircraft according to claim 1, wherein the aircraft has no landing gear.

12. An aircraft according to claim 1, wherein the structure of the wing comprises at least one space frame and at least one cover supported by the space frame, wherein the space frame has one or more structural members, the structural members including a structural foam material.

13. An aircraft according to claim 12, wherein the cover is pre-stressed and the pre-stressed cover has the aerodynamic surface of the wing.

14. An aircraft according to claim 12, wherein the space frame comprises one or more chordwise ribs and one or more longitudinal spars.

15. An aircraft according to claim 12, wherein the structural member(s) consist of a structural foam material.

16. An aircraft according to claim 12, wherein the structural foam material is a cellular core foam of for example polystyrene, polycarbonate, polyvinyl chloride, polypropylene, acrylonitrile-butadiene-styrene or a polymethacrylimide (PMI) foam such as Rohacell™.

17. An aircraft according to claim 1, wherein the structural failure of the wing includes plastic deformation of the wing.

18. An aircraft according to claim 6, wherein the aircraft is exclusively solar powered.

19. A method of launching an aircraft, the aircraft comprising a wing providing the main lifting surface for the aircraft, the wing having a structure supporting an aerodynamic surface, wherein the wing has a weight, the wing structure being unable to support its own weight when the aircraft is stationary and under a load of 1 g so as to cause structural failure of the wing the method comprising lifting the aircraft from a substantially ground level location to an elevated altitude by a lighter than air carrier.

20. A method of launching an aircraft according to claim 19, wherein the aircraft is attached to the lighter than air carrier via one or more tethers during ascent from the substantially ground level location to the elevated altitude, the tethers being severed at altitude to launch the aircraft.

21. A method of launching an aircraft according to claim 19, wherein the elevated altitude is from 18,000 to 30,000 metres.

22. An aircraft according to claim 1, wherein the wing structure is configured to be supported prior to flight and being unable to support its own weight when the aircraft is stationary and under a load of 1 g so as to cause structural failure of the wing if the wing is unsupported prior to flight.

23. A method of launching an aircraft according to claim 19, wherein the wing structure is configured to be supported prior to flight and being unable to support its own weight when the aircraft is stationary and under a load of 1 g so as to cause structural failure of the wing if the wing is unsupported prior to flight.
